(19) United States
(12) Patent Application Publication
(10) Pub. No.: US 2021/0387795 A1
(43) Pub. Date: Dec. 16, 2021

(54) Reusable Mask Storage and Donning & Doffing Device

(71) Applicant: Mamta Mehta Miles, Falls Church, VA (US)

(72) Inventor: Mamta Mehta Miles, Falls Church, VA (US)

(21) Appl. No.: 17/327,693

(22) Filed: May 22, 2021

Related U.S. Application Data
(60) Provisional application No. 63/029,412, filed on May 23, 2020.

(51) Int. Cl. B65D 85/18; A62B 18/08; B65D 43/16

(52) U.S. Cl. CPC B65D 85/18; B65D 43/16; A62B 18/084

(57) ABSTRACT

A container for storing a face mask that allows the user to don and doff the mask while making minimal contact with the mask. The outside of the receptacle portion of the container includes a mask strap guide that holds the face mask straps in place while they are stretched over the mask strap retention structures which are also incorporated into the outside of the receptacle portion of the container. By retaining the face mask straps on the outside of the receptacle portion of the container the mask is held in place and can be donned or doffed while only touching the face mask straps. The container includes a lid attached via a hinge to cover the receptacle portion of the container. The outside of the receptacle portion of the container includes a port allowing for the infusion of sanitizing agents into the receptacle containing the mask.

### BACKGROUND OF THE INVENTION

This invention was developed as a response to the problem of reusing medical masks in a hospital or other environment. With the onset of COVID-19 and a lack of personal protective equipment, health care providers as well as non-medical persons are reusing masks that have been contaminated by airborne contaminants including potentially dangerous pathogens. When one is reusing a contaminated mask the problem that arises is that by touching the contaminated/used mask you may transfer those contaminants to your hands. It has been suggested that humans touch their faces up to 16 times an hour, this poses a very high risk to the mask wearer who has donned (put on) or doffed (removed) a contaminated mask. It also poses a risk to others as the individual who has contaminated themselves may go on to touch other people (e.g. shaking hands) or to contaminate surfaces. Although hand hygiene and washing has often been described as the best way to minimize the spread of contaminants, this is not always practical or possible. While wearing masks in everyday life it is not always realistic that there will be a sink nearby or that one would have a simple and convenient way to wash or sanitize one's hands each time a mask is used. Additionally, when a contaminated mask is removed it is often placed directly on a surface, such as a table, or left uncovered and uncontained on the user (e.g. hanging around their neck, or attached to a waistband). This creates even more opportunities to inadvertently spread contaminants from the mask and increases the likelihood of damaging the mask—increasing the usage rate of a potentially scarce resource. Having a device that can both minimize contact with a mask when donning and doffing it as well as providing a convenient and protective storage receptacle would mitigate some of the aforementioned risks.

### BRIEF SUMMARY OF THE INVENTION

Disclosed herein is a reusable mask storage device that is portable, can be sanitized and reduces direct contact with masks when they are donned and doffed. In its preferred form it will comprise a container of sufficient size to accommodate a mask, a lid to contain a mask in said container, structural features to retain the straps of the mask, and a structure that allows the device to be attached to the clothing or body of the user via mechanisms including, but not limited to, clips, straps, and retractable reels.

### BRIEF DESCRIPTION OF DRAWINGS

FIG. 1 Shows an overhead perspective view of the invention with the lid open.

FIG. 2 Shows an underside perspective view of the invention with the lid open.

FIG. 3 Shows an overhead perspective view of the invention with the lid closed.

FIG. 4 Shows an overhead perspective view of the invention with the lid open and a mask inside.

FIG. 5 Shows an overhead perspective view of the invention without the access port, with the lid open, the opening of the receptacle for the mask facing downwards, and an alternate arrangement of the mask strap guides and mask strap retention structures.

FIG. 6 Shows an overhead perspective view of the invention without the access port, with the lid open, the opening of the receptacle for the mask facing downwards, an alternate arrangement of the mask strap guides and mask strap retention structures, and the straps of a mask stored in the invention visible.

### REFERENCE NUMERALS IN THE DRAWINGS

1. Lid
2. Receptacle for mask
3. Hinge
4. Tab for attachment of clips
5. Mask strap retention structure
6. Mask strap guide
7. Access port
8. Grooves of the mask strap retention structure
9. Mask
10. Upper mask strap
11. Notches in the rim of the mask receptacle
12. Lower mask strap

### DETAILED DESCRIPTION OF THE INVENTION

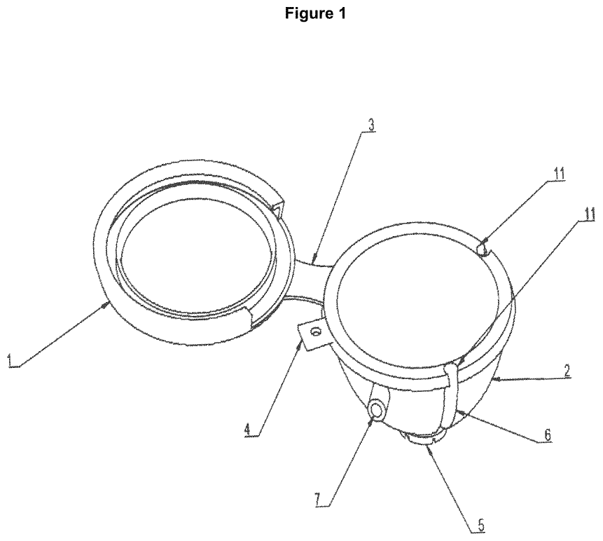

FIG. 1 Shows an overhead perspective view of the invention with the lid open. The exact configuration of the features shown may vary, the figure is intended to show the functionality of the invention but not to restrict it or any of its features to a particular size, shape, orientation, or quantity. The receptacle for the mask 2 is of sufficient size to accommodate a mask such as, but not limited to, N95 masks—which are a mainstay of personal protective equipment in most medical facilities. The receptacle for the mask 2 is attached to a lid 1 via a hinge 3. An access port 7 is incorporated into the receptacle for the mask 2. The access port 7 allows for the infusion of substances into the receptacle for the mask 2 for the purpose of sanitizing or otherwise optimizing the condition of a mask placed in the invention, allowing said mask to be more safely reused. The use of the access port 7 is not limited to sanitizing but could be used to provide other useful options, including but not limited to, ventilation, and placement of probes to monitor the temperature or other parameters within the invention. The location of the access port 7 need not be limited to the receptacle for the mask 2 (e.g. it could provide access via the lid 1 when closed). Along the rim of the receptacle for the mask 2 are a plurality of notches in the rim of the mask receptacle 11. These notches allow the mask straps to transition from their attachment point on the mask to the outside of the receptacle for the mask 2 without interfering with the closure of the lid 1 and without sliding out of position along the rim of the receptacle for the mask 2. The receptacle for the mask 2 includes a tab for the attachment of clips 4, said tab contains an opening/hole that allows for the invention to be attached to clips (e.g. carabiners) or other connective devices making the invention highly portable and easy to carry on one's person when not in use for donning or doffing.

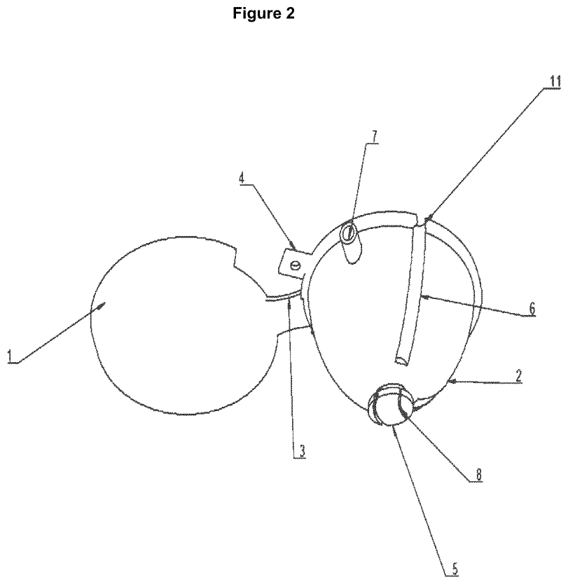

FIG. 2 Shows an underside perspective view of the invention with the lid open. On the outside of the receptacle for the mask 2 is a mask strap retention structure 5 and mask strap guides 6. When the invention is being used, the straps from the mask that is being stored are placed in the mask strap guides 6 preventing them from sliding along the outside of the receptacle for the mask 2, and causing the mask straps to travel a longer and less direct path to the mask strap retention structure 5. The longer path that the mask straps have to travel along the mask strap guides 6 mean that when they are looped over, run through, or otherwise held in place by the mask strap retention structure 5 they will be taught enough to hold their position (as well as assist in securing the mask inside the receptacle for the mask 2). The mask strap retention structure 5 is depicted as an elliptical shaped projection from the center of the underside of the receptacle for the mask 2 that gets larger/wider as it extends further away from the receptacle for the mask 2. The shape of the mask strap retention structure 5 allows for the straps from a mask being stored in the invention to be looped over it and thus prevented from sliding out of position by one or both of the following: tension on the mask straps that have been placed in the mask strap guides 6 and the wider and larger outermost (furthest away from the receptacle for the mask 2) portion of the mask strap retention structure 5. The outermost surface of the mask strap retention structure 5 is shown with curved grooves, these grooves of the mask strap retention structure 8 represent an alternative for securing the straps of a mask placed in the invention, as they could be run through these grooves, with the possibility of separating the two (upper and lower) straps of a typical N95 mask. Not all masks have the same design, and their straps may vary in position, number, or other design characteristics, as such the invention features may be modified to preserve their function while accommodating masks of varying design. The mask strap retention structure 5 may also be designed to hold the straps of a mask being stored in the invention by means of other mechanisms, including but not limited to, clips, hooks, and clasps.

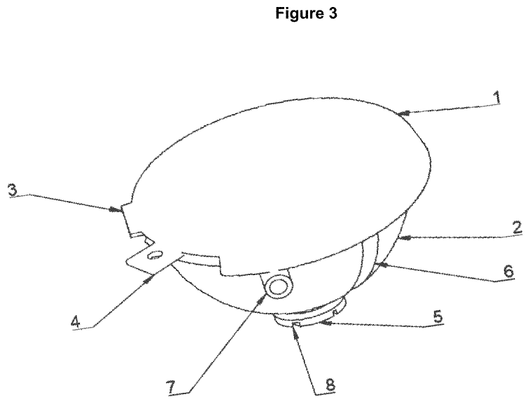

FIG. 3 Shows an overhead perspective view of the invention with the lid 1 closed. It should be noted that the hinge 3 in its preferred form would be designed as a one piece ‘living’ hinge, but is not limited to this configuration. The lid 1 meets the rim of the receptacle for the mask 2 and is held in place securely through a ‘press on’ type closure wherein the rim of the receptacle for the mask 2 nests within the contours of the inner portion of the lid 1. This is not intended to limit the lid closure to just this method; numerous other closure designs would be possible, including but not limited to, latch mechanisms, pin-and-tuck style closures, and twist off designs (which would be particularly useful if the invention where to be configured without a hinge—allowing the lid 1 to be separate from the receptacle for the mask 2). It should be noted that the invention can be designed to have a lid 1 where the seal formed between it and the receptacle for the mask 2 may range from being airtight to one that creates a gap that allows airflow to the interior of the invention when the lid 1 is closed.

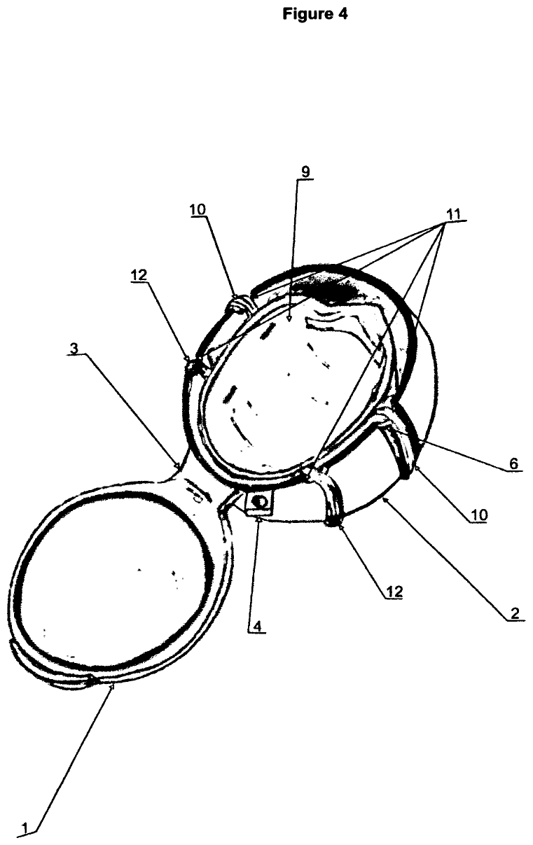

FIG. 4 Shows an overhead perspective view of the invention with the lid open and a mask 9 positioned in the receptacle for the mask 2. The upper and lower mask straps 10 & 12 run through the notches in the rim of the mask receptacle 11. In FIG. 4 four notches are shown in the rim of the mask receptacle instead of the two in the other figures. The upper mask strap 10 continues from the notches in the rim of the mask receptacle 11 into the mask strap guides 6 which leads the mask straps towards the mask strap retention structure 5 (not visible in FIG. 4). Note that only one mask strap guide 6 is visible (in the foreground of the drawing with the upper mask strap 10 passing through it), this is to aid in the visualization of the notches in the rim of the mask receptacle 11. The access port 7 is also not shown to illustrate that the invention can be designed without this access port when preferred.

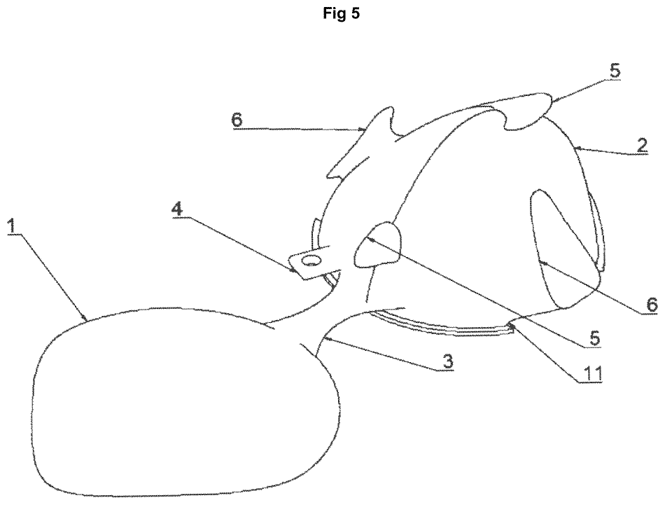

FIG. 5 Shows an overhead perspective view of the invention without the access port, with the lid open, the opening of the receptacle for the mask facing downwards, and an alternate arrangement of the mask strap guides 6 and mask strap retention structures 5. The mask strap guides 6 are shown as wing-like projections from the outside of the receptacle for the mask 2 but serve the same purpose as the more groove-like mask strap guides shown in FIGS. 1-4. In both cases the mask strap guides serve the purpose of holding in place the straps of a face mask being placed in the invention. In addition they also serve the purpose of making the path of the face mask straps to be less direct (longer) thereby increasing the tension on these elastic straps so that they can be securely looped over the mask strap retention structures 5. The mask strap retention structures 5 are also shown in an alternate arrangement in FIG. 5 as they are now two separate projections on the outside of the receptacle for the mask 2. This embodiment of the invention is also well suited for face masks that have over the ear style straps (as opposed to the over the head style straps typically used on N95/N100 masks to provide a tighter fit). If the invention is used to store or don and doff masks with over the ear style straps then the mask strap guides 6 can take on the same function as the mask strap retention structure 5, as with this style of mask the two pairs of straps are rotated 90° relative to the strap position on a mask with over the head style straps. That is, the straps of a mask with over the ear style straps can simply be looped over the wing-like projections of the mask strap guides 6 and be held in place by the tension in said straps as the mask is contained within the receptacle for the mask 2. Furthermore, this embodiment of the invention shows the notches in the rim of the mask receptacle 11 as being significantly wider than in FIGS. 1-4.

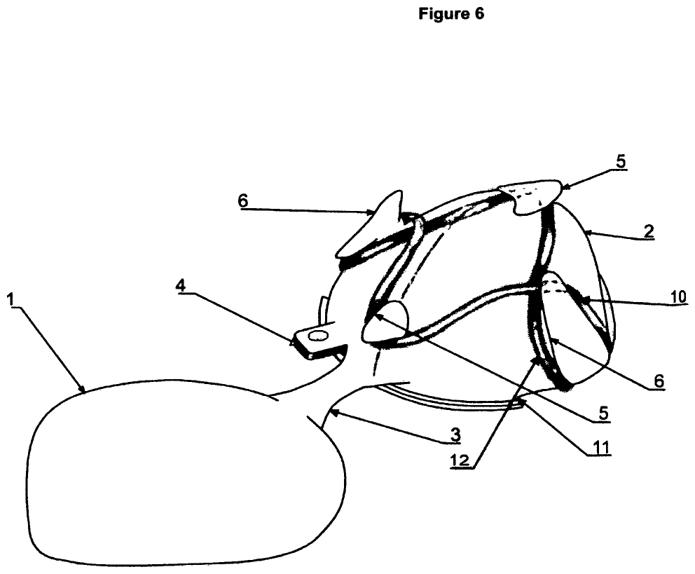

FIG. 6 is also an overhead perspective view of the invention without the access port, with the lid open, the opening of the receptacle for the mask facing downwards, and the mask strap guides 6, and mask strap retention structures 5 configured as they were in FIG. 5. The reason for this drawing is to visualize the path of the mask straps (upper mask straps 10 and lower mask straps 12) as they are held in place by the mask strap guides 6 and the mask strap retention structures 5. The mask being stored in this drawing has over the head style straps (e.g. N95 mask). The wider notches in the rim of the mask receptacle 11 allow both the upper and lower mask straps 10 & 12 to rest within the same notch, in contrast to having four separate notches in the rim of the mask receptacle as shown in FIG. 4.

The design of the invention allows for the user to don and doff their mask while making minimal contact with their mask. To use the invention to remove a mask the user simply opens the lid 1 when appropriate, places the invention in front of their face, and allows the mask to enter the receptacle for the mask 2 while moving the mask straps into position to be secured along the outside of the receptacle for the mask 2, as previously described, and finally closing the lid 1 when appropriate. Putting on a mask that is stored in the invention is done by reversing the steps required for removal. The invention can be manufactured with a variety of materials, including but not limited to, silicone, polypropylene, and ABS. Depending on the application, the invention can be manufactured to provide a structure ranging from rigid to highly flexible.

1. A face mask container comprising:
a receptacle of sufficient volume to accommodate a face mask; a lid connected via a hinge to said receptacle that can be closed to cover said receptacle; at least one mask strap guide member incorporated into the outside surface of said receptacle; and at least one mask strap retention member that is incorporated to the outer surface of said receptacle.

2. A face mask container as in claim 1, wherein a tab for the attachment of clips is included, comprising a projection from said receptacle that includes a hole through said projection.

3. A face mask container as in claim 1, wherein an access port is incorporated into the outer surface of said receptacle comprising a hollow tube member that provides a pathway through said hollow tube to the cavity of said receptacle.

4. A face mask container as in claim 2, wherein an access port is incorporated into the outer surface of said receptacle comprising a hollow tube member that provides a pathway through said hollow tube to the cavity of said receptacle.

5. A face mask container comprising:
a receptacle of sufficient volume to accommodate a face mask; a lid connected via a hinge to said receptacle that can be closed to cover said receptacle; and at least one mask strap guide member incorporated into the outside surface of said receptacle.

6. A face mask container as in claim 5, wherein a tab for the attachment of clips is included, comprising a projection from said receptacle that includes a hole through said projection.

7. A face mask container as in claim 5, wherein an access port is incorporated into the outer surface of said receptacle comprising a hollow tube member that provides a pathway through said hollow tube to the cavity of said receptacle.

8. A face mask container as in claim 6, wherein an access port is incorporated into the outer surface of said receptacle comprising a hollow tube member that provides a pathway through said hollow tube to the cavity of said receptacle.

9. A face mask container comprising:
a receptacle of sufficient volume to accommodate a face mask; a lid with no permanent attachment to said receptacle that can be attached to and cover said receptacle; at least one mask strap guide member incorporated into the outside surface of said receptacle; and at least one mask strap retention member that is incorporated to the outer surface of said receptacle.

10. A face mask container as in claim 9, wherein a tab for the attachment of clips is included, comprising a projection from said receptacle that includes a hole through said projection.

11. A face mask container as in claim 9, wherein an access port is incorporated into the outer surface of said receptacle comprising a hollow tube member that provides a pathway through said hollow tube to the cavity of said receptacle.

12. A face mask container as in claim 10, wherein an access port is incorporated into the outer surface of said receptacle comprising a hollow tube member that provides a pathway through said hollow tube to the cavity of said receptacle.
